(19) United States
(12) Patent Application Publication
(10) Pub. No.: US 2021/0142007 A1
(43) Pub. Date: May 13, 2021

(54) ENTITY IDENTIFICATION SYSTEM

(71) Applicant: NTT DOCOMO, INC., Chiyoda-ku (JP)

(72) Inventor: Yutaro SHIRAMIZU, Chiyoda-ku (JP)

(73) Assignee: NTT DOCOMO, INC., Chiyoda-ku (JP)

(21) Appl. No.: 17/041,927

(22) PCT Filed: Jun. 4, 2019
(86) PCT No.: PCT/JP2019/022218

§ 371 Date: Sep. 25, 2020

(30) Foreign Application Priority Data
Jun. 28, 2018 (JP) 2018-123451

(51) Int. Cl. G06F 40/295

(52) U.S. Cl. CPC G06F 40/295

(57) ABSTRACT

An entity identification system includes: an input unit configured to input a sentence; a phrase extracting unit configured to extract one or more phrases from the input sentence; a candidate converting unit configured to convert at least one of the extracted phrases into one or more candidate phrases for an entity linked to the phrase; a combination generating unit configured to generate one or more combinations of phrases, which correspond to the sentence, each including one of the one or more phrases that are converted; a score calculating unit configured to calculate a score of each of the generated combinations on the basis of a score for a similarity between phrases included in the combination; and an entity identifying unit configured to identify a phrase for the linked entity from among the one or more candidate phrases on the basis of the calculated score of the combination.

### TECHNICAL FIELD

The present invention relates to an entity identification system that identifies an entity linked to a phrase in a sentence.

### BACKGROUND ART

Entity linking that associates a phrase (keyword) in a sentence with an entity corresponding to the phrase is known. An entity is a concept of a phrase in a sentence (represented by the phrase in the sentence). For example, analyzing a document on a web page including information on the names of people collected from a database on the Internet and extracting different expressions for famous people (nicknames and the like) is illustrated in Patent Literature 1.

### CITATION LIST

### Patent Literature

[Patent Literature 1] Japanese Unexamined Patent Publication No. 2008-130034

### SUMMARY OF INVENTION

### Technical Problem

In conventional entity linking, an entity linked to a phrase is identified on the basis of a context, a link probability, and the like. However, in the conventional method, there are cases in which it is difficult to identify an appropriate entity from entity candidates.

One embodiment of the present invention has been realized in view of the description presented above, and an object thereof is to provide an entity identification system capable of identifying an entity that is appropriate for a context of a sentence.

### Solution to Problem

In order to achieve the object described above, an entity identification system according to one embodiment of the present invention includes: an input unit configured to input a sentence; a phrase extracting unit configured to extract one or more phrases from the sentence input by the input unit; a candidate converting unit configured to convert at least one of the phrases extracted by the phrase extracting unit into one or more candidate phrases for an entity linked to the phrase; a combination generating unit configured to generate one or more combinations of phrases, which correspond to the sentence, each including one of the one or more phrases converted by the candidate converting unit; a score calculating unit configured to calculate a score of each of the combinations generated by the combination generating unit on the basis of a score for a similarity between phrases included in the combinations; and an entity identifying unit configured to identify a phrase for the linked entity from among the one or more candidate phrases on the basis of the scores of the combinations calculated by the score calculating unit.

In an entity identification system according to one embodiment of the present invention, a phrase of an entity linked to a phrase included in a sentence is identified on the basis of a similarity between phrases corresponding to sentences. Therefore, according to an entity identification system according to one embodiment of the present invention, an entity that is appropriate for a context of a sentence can be identified.

### Advantageous Effects of Invention

According to one embodiment of the present invention, a phrase of an entity linked to a phrase included in a sentence is identified on the basis of a similarity between phrases corresponding to sentences, and accordingly, an entity that is appropriate for a context of the sentence can be identified.

### BRIEF DESCRIPTION OF DRAWINGS

FIG. 1 is a diagram illustrating the configuration of an entity identification system according to an embodiment of the present invention.

FIG. 2 is a diagram illustrating an example of phrases extracted from a sentence.

FIG. 3 is a diagram illustrating an example of candidate phrases for an entity converted from a phrase in a sentence.

FIG. 4 is a diagram illustrating an example of a combination of phrases.

FIG. 5 is a flowchart illustrating a process executed by an entity identification system according to an embodiment of the present invention.

FIG. 6 is a diagram illustrating the hardware configuration of an entity identification system according to an embodiment of the present invention.

### DESCRIPTION OF EMBODIMENTS

Hereinafter, an entity identification system according to an embodiment of the present invention will be described in detail with reference to the drawings. In addition, in description of the drawings, the same reference sign will be assigned to elements which are the same, and duplicate description thereof will be omitted.

FIG. 1 illustrates an entity identification system 10 according to this embodiment. The entity identification system 10 is a device (system) that inputs a sentence (text or a character string) and identifies entities linked to phrases included in the input sentence. In other words, the entity identification system 10 is a device that performs entity linking. In addition, in this embodiment, a sentence in Japanese will be described as an example. However, also in a sentence written in a language other than Japanese, entities can be similarly identified. For example, in a case in which a phrase “Renpo Saibansyo (Federal Court)” is included in a sentence, the entity identification system 10 may determine which one of the entities “America Gassyukoku Renpo Saibansyo (U.S. Federal Court),” “Renpo Saibansyo (Germany) (Federal Court (Germany)),” “Renpo Saibansyo (Switzerland) (Federal Court (Switzerland)),” and “Australia Renpo Saibansyo (Australia Federal Court)” is represented by “Renpo Saibansyo (Federal Court)” in the sentence.

For example, the identifying of entities using the entity identification system 10 may be performed as a pre-process for extracting named entities from a sentence or may be performed for performing word sense disambiguation for a phrase in a sentence. In addition, the identifying of entities may be performed for a purpose other than those described above. For example, the entity identification system 10 may be realized by a server device. In addition, the entity identification system 10 may be a part of a certain client-server type system (for example, an interactive system) or may be a single device.

Subsequently, the function of the entity identification system 10 according to this embodiment will be described. As illustrated in FIG. 1, the entity identification system 10 is configured to include an input unit 11, a phrase extracting unit 12, a candidate converting unit 13, a combination generating unit 14, a score calculating unit 15, and an entity identifying unit 16.

The input unit 11 is a functional unit that inputs a sentence including phrases that are targets for identifying entities. The input unit 11, for example, receives and inputs a sentence transmitted from a terminal to the entity identification system 10. Alternatively, the input unit 11 may receive voice from a terminal, perform voice recognition for the received voice, and acquire and input a sentence that is a result of the voice recognition (in other words, an input using voice data). In such a case, the input unit 11 can perform voice recognition using an arbitrary conventional voice recognition method. In addition, the input unit 11 may automatically generate and input a sentence in the form of voice data or text data in accordance with a user's instruction on the basis of generation rules set in advance. Furthermore, the input unit 11 may input a sentence using an arbitrary method other than those described above. The input unit 11 outputs the input sentence to the phrase extracting unit 12.

The phrase extracting unit 12 is a functional unit that extracts one or more phrases from a sentence input by the input unit 11. The phrases extracted by the phrase extracting unit 12 include phrases that are targets to which entities are linked. In addition, phrases extracted by the phrase extracting unit 12 may include phrases that are not targets to which entities are linked. As will be described later, phrases that are not targets to which entities are linked may be also used for identifying entities. Phrases that are extracted may be in units of words, phrases formed from a plurality of words, or character strings in an arbitrary unit. One or more phrases or a plurality of phrases may be extracted. For example, the phrase extracting unit 12 may extract phrases as follows.

The phrase extracting unit 12 inputs a sentence from the input unit 11. For example, the phrase extracting unit 12 extracts phrases using morphological analysis. In this case, the phrase extracting unit 12 divides the input sentence into morphemes using morphological analysis. The morphological analysis may be performed using a conventional method. The phrase extracting unit 12 may extract all the morphemes acquired by dividing the sentence into phrases. Alternatively, some of the morphemes may be extracted as phrases. More specifically, the phrase extracting unit 12 may extract morphemes as phrases on the basis of a part of speech assigned to each of the morphemes using morphological analysis. For example, a part of speech (for example, noun) to be extracted as a phrase or a part of speech not extracted as a phrase may be set in advance.

In addition, the phrase extracting unit 12 may input a corpus and extract phrases from a sentence on the basis of the input corpus. For example, as the corpus, an online encyclopedia (for example, Wikipedia), an online dictionary, or the like may be used. For example, the input of a corpus may be performed by an operation of an administrator of the entity identification system 10. More specifically, the phrase extracting unit 12 may calculate appearance frequencies of phrases appearing in the corpus and extract phrases on the basis of the appearance frequencies of the phrases. For example, among phrases acquired using morphological analysis, phrases of which appearance frequencies are equal to or higher than an appearance frequency set in advance may be excluded from phrases to be extracted as general phrases.

In addition, instead of or in addition to the morphological analysis, the phrase extracting unit 12 may extract phrases using a dictionary, which is used for extracting phrases, stored in advance. The dictionary for extracting phrases is acquired by forming a list of phrases to be extracted. The dictionary for extracting phrases may be artificially generated by an administrator of the entity identification system 10 or the like. Alternatively, the dictionary for extracting phrases may be generated on the basis of the corpus described above. For example, among phrases appearing in the corpus, a list of phrases of which appearance frequencies are lower than an appearance frequency set in advance may be configured as a dictionary for extracting phrases. The phrase extracting unit 12 performs matching of character strings by comparing each phrase included in the dictionary for extracting phrases with an input sentence and extracts phrases included in the sentence. The phrase extracting unit 12 outputs the extracted phrases to the candidate converting unit 13.

FIG. 2(a) illustrates an example of phrases extracted through morphological analysis from a sentence “Gassyukoku Saiko Saibansyo Ha Bei Seifu No Renpo Saibansyo Wo Toukatsu Suru (The U.S. Supreme Court controls federal courts of the U.S. government).” FIG. 2(b) illustrates an example of phrases extracted from the sentence using a dictionary for extracting phrases. For example, “Gassyukoku Saiko Saibansyo (U.S. Supreme Court)” is divided into phrases of the three words “Gassyukoku (U.S.),” “Saiko (Supreme),” and “Saibansyo (Court)” in a case in which morphological analysis is used. However, in a case in which a dictionary for extracting phrases is used, when a phrase “Gassyukoku Saiko Saibansyo (U.S. Supreme Court)” is included in the dictionary, a phrase of one word “Gassyukoku Saiko Saibansyo (U.S. Supreme Court)” is extracted. Hereinafter, description will be presented using an example of phrases in a case in which a dictionary for extracting phrases is used.

The candidate converting unit 13 is a functional unit that converts at least one of phrases extracted by the phrase extracting unit 12 into one or more candidate phrases for entities linked to the phrases. For example, the candidate converting unit 13 converts phrases into candidate phrases for entities as follows.

The candidate converting unit 13 stores each phrase that may appear in a sentence and a phrase representing an entity that may be linked to the phrase in association with each other in advance. A phrase representing an entity that is stored is a conversion candidate for a phrase in a sentence, in other words, a candidate phrase of an entity linked to a phrase that may appear in a sentence. For example, the candidate converting unit 13 stores phrases representing entities such as “America Gassyukoku Renpo Saibansyo (U.S. Federal Court),” “Renpo Saibansyo (Germany) (Federal Court (Germany)),” “Renpo Saibansyo (Switzerland) (Federal Court (Switzerland)),” “Australia Renpo Saibansyo (Australia Federal Court),” and the like in advance in association with a phrase “Renpo Saibansyo (federal court)” that may appear in a sentence as illustrated in FIG. 3. For one phrase that may appear in a sentence, there may be one or a plurality of candidate phrases for entities.

The information described above may be artificially created by an administrator or the like of the entity identification system 10. Alternatively, the information described above may be generated on the basis of the corpus described above. For example, the information may be generated on the basis of anchor text included in the corpus. Alternatively, the information may be generated on the basis of a character string distance (for example, a cosine distance to be described later) between phrases determined on the basis of the corpus.

The candidate converting unit 13 receives phrases from the phrase extracting unit 12 as inputs. For each phrase input from the phrase extracting unit 12, the candidate converting unit 13 checks whether or not the phrase is included in the above-described information stored in advance. The candidate converting unit 13 converts the phrase included in the information stored in advance into a phrase representing an entity associated with the phrase in the information. The candidate converting unit 13 outputs a candidate phrase for the entity after conversion for each phrase extracted by the phrase extracting unit 12 to the combination generating unit 14. In addition, also for a phrase not included in the information stored in advance among phrases input from the phrase extracting unit 12, the candidate converting unit 13 may output the phrase (not converted) to the combination generating unit 14. The phrase not included in the stored information is a phrase that does not become a target for identifying an entity.

The combination generating unit 14 is a functional unit that generates one or more combinations of phrases corresponding to a sentence that includes one or more phrases converted by the candidate converting unit 13.

The combination generating unit 14 receives phrases from the candidate converting unit 13 as an input. The combination generating unit 14 generates a combination of phrases for each sentence input by the input unit 11, in other words, for each sentence including phrases that are targets for identifying entities. For one combination, the combination generating unit 14, for each phrase extracted by the phrase extracting unit 12, includes any one of candidate phrases for entities converted by the candidate converting unit 13. The combination generating unit 14 generates a combination of candidate phrases for all the entities. In this way, a combination of products corresponding to the number of candidate phrases for entities after conversion is generated. For a certain phrase, in a case in which there are a plurality of candidate phrases for entities, there are also a plurality of combinations. An example of the combination is illustrated in FIG. 4.

The combination generating unit 14 may use only some phrases among candidate phrases for entities after conversion that are input from the candidate converting unit 13 for generation of a combination. More specifically, the combination generating unit 14 may perform filtering of phrases using character string lengths of candidate phrases for entities or appearance frequencies of the phrase in the corpus and use the filtered phrases for generating a combination. For example, in a case in which a character string length of a candidate phrase for an entity is within a range set in advance or in a case in which an appearance frequency of the phrase in the corpus is equal to or higher than a value set in advance or is equal to or higher than a rank, which has been set in advance, among converted phrases, the combination generating unit 14 may use the phrase for generating a combination. For example, the reason for using a character string length for filtering is that a candidate phrase of which a character string length, which is mechanically extracted, is extremely short or long may not be appropriate as a phrase representing an entity. In addition, filtering may be performed using both a character string length of a candidate phrase for an entity and an appearance frequency of the phrase in the corpus. In accordance with such filtering, for example, only the two of “America Gassyukoku Renpo Saibansyo (U.S. Federal Court)” and “Renpo Saibansyo (Germany) (Federal Court (Germany))” among a plurality of candidates converted from a phrase “Renpo Saibansyo (Federal Court)” may be used for generating a combination on the basis of appearance frequencies thereof in the corpus.

By decreasing the number of candidates of phrases through filtering and decreasing the number of combinations of phrases in accordance therewith, the amount of calculation can be reduced. For example, when three phrases can be extracted from a sentence, and the numbers of candidate phrases for such phrases are respectively three, five, and three, the number of combinations to be generated is 3×5×3=45. If individual phrase candidates are excluded through filtering, the number of combinations to be generated is 2×4×2=16, and the amount of calculation can be cut to a half or less.

The filtering of candidate phrases may be performed in accordance with the number of combinations of phrases in a case in which filtering is not performed. For example, the filtering may be performed in a case in which the number of combinations of phrases in a case in which the filtering is not performed is equal to or larger than a threshold set in advance. In this way, the filtering can be appropriately performed in a case in which reduction in the amount of calculation is considered to be necessary. In addition, the filtering of phrase candidates may be performed by the candidate converting unit 13. Furthermore, the candidate converting unit 13 may store candidate phrases after filtering as phrases for conversion in advance.

The combination generating unit 14 may use candidate phrases for entities of all the phrases extracted by the phrase extracting unit 12 for generating a combination or may use candidate phrases for entities of some phrases for generating a combination. More specifically, the combination generating unit 14 may determine phrases to be used for generating a combination on the basis of parts of speech of phrases extracted by the phrase extracting unit 12 or appearance frequencies of phrases appearing in the corpus. For example, a part of speech may be used similar to a case in which phrases are extracted by the phrase extracting unit 12. Alternatively, in a case in which an appearance frequency of a phrase in the corpus is equal to or higher than a value set in advance or in a case in which a rank of a phrase among extracted phrases is equal to or higher than a rank set in advance, a candidate phrase for an entity of the phrase may be used for generating a combination. In addition, phrases used for generating a combination may be determined on the basis of both parts of speech of the phrases and appearance frequencies of the phrases appearing in the corpus. In this way, for example, among candidates for the three phrases “Gassyukoku Renpo Saibansyo (U.S. Supreme Court),” “Bei Seifu (U.S. government),” and “Renpo Saibansyo (Federal Court),” only candidates for two phrases “Gassyukoku Renpo Saibansyo (U.S. Supreme Court)” and “Renpo Saibansyo (Federal Court)” may be used for generating a combination. As described above, by decreasing the number of combinations of phrases, similar to the case of the filtering described above, the amount of calculation can be reduced. In addition, the determination of phrases used for generating a combination (corresponding to extraction of phrases using the phrase extracting unit 12) may be performed by only one of the phrase extracting unit 12 and the combination generating unit 14 using uniform criteria.

The generation of a combination using only some of phrases extracted by the phrase extracting unit 12 may be performed in accordance with the number of combinations of phrases in a case in which all the phrases are used for generating combinations. For example, in a case in which the number of combinations of phrases in a case in which all the phrases are used for generating combinations is equal to or larger than a threshold set in advance, only some of the phrases may be used for generating combinations. In this way, in a case in which reduction in the amount of calculation is considered to be necessary, the number of phrases can be appropriately reduced. In addition, in such a case, in order to significantly reduce the number of phrases using the combination generating unit 14, extraction of phrases using the phrase extracting unit 12 may be performed without using parts of speech of the phrases or appearance frequencies of phrases appearing in the corpus or may be performed using criteria different from that used for reducing the number of phrases using the combination generating unit 14 (loose) even in a case in which parts of speech of the phrases or appearance frequencies of the phrases are used.

In a case in which a phrase that has not been converted into a candidate phrase for an entity is included in phrases input from the candidate converting unit 13, the combination generating unit 14 may generate a combination including the phrase. The combination generating unit 14 outputs information representing the generated combination to the score calculating unit 15.

The score calculating unit 15 is a functional unit that, for each combination generated by the combination generating unit 14, calculates a score on the basis of a score for a similarity between phrases included in the combination. The score calculating unit 15 may input a corpus and calculate a score for a similarity between phrases on the basis of the input corpus. For example, the score calculating unit 15 calculates a score for each combination as follows.

The score calculating unit 15 inputs information representing a combination from the combination generating unit 14. The score calculating unit 15 identifies a score for a similarity between two phrases included in a combination. For example, the score for a similarity between phrases is calculated as follows. The score calculating unit 15 receives a corpus as an input and calculates a score for a similarity between two phrases on the basis of the corpus. For example, the calculation of a score of a similarity between phrases on the basis of the corpus may be performed using a technique for performing an analysis of phrases using machine learning such as Word2Vec or the like. In a case in which Word2Vec is used, a cosine distance between word vectors representing characteristics of phrases may be used as a similarity. Alternatively, a similarity may be calculated on the basis of a co-occurrence probability between phrases. In addition, similarities based on the corpus may be calculated in advance for all the combinations of phrases and be stored in the score calculating unit 15. Furthermore, a similarity between phrases may be calculated using a method other than those described above or may be generated in advance by another device or artificially and used.

The score calculating unit 15 calculates a score for a similarity between every two phrases included in a combination. The score calculating unit 15 calculates a score for the entire combination on the basis of scores of the similarities. For example, the score calculating unit 15 calculates a scores of the entire combination by adding scores of similarities between every two phrases included in the combination. The score calculating unit 15 calculates scores of all the combinations. The score calculating unit 15 outputs information representing the combinations and the calculated scores to the entity identifying unit 16.

The entity identifying unit 16 is a functional unit that identifies a phrase of an entity linked from one or more candidate phrases on the basis of the scores of combinations calculated by the score calculating unit 15.

The entity identifying unit 16 receives information representing the combinations and the scores from the score calculating unit 15 as inputs. A score represents a validity of a candidate phrase for an entity included in a combination for a sentence. For example, in a case in which a similarity becomes higher as the value of the score for a similarity between two phrases described above becomes higher, this represents that the validity of a candidate phrase for an entity included in a combination for the sentence becomes higher as the score of the combination is higher.

The entity identifying unit 16 identifies a candidate phrase for an entity included in a combination of which a score represents that the validity described above is the highest (for example, the score is the highest) among combinations as a phrase of an entity linked to a corresponding phrase. In addition, the entity identifying unit 16 may compare a score with a threshold set in advance and identify an entity in a case in which the score is equal to or higher than the threshold. In a case in which the score is lower than the threshold, the entity identifying unit 16 may determine that there is no entity (among candidates) linked to the phrase. As described above, the entity identifying unit 16 may identify phrases of entities linked to all the phrases included in the sentence once on the basis of scores (consistence of the combination) instead of identifying an entity for each phrase included in the sentence.

The entity identifying unit 16 outputs the phrase of the entity that has been identified to a system, a module, and the like in which the phrase is used. In addition, the outputting of the phrase of the entity that has been identified may be performed using an arbitrary method. The function of the entity identification system 10 according to this embodiment is thus as described above.

Subsequently, a process executed by the entity identification system 10 according to this embodiment (an operation method performed by the entity identification system 10) will be described with reference to a flowchart illustrated in FIG. 5. In this process, a sentence including phrases that are targets for identifying entities is input by the input unit 11 (S01). Subsequently, phrases are extracted from the sentence by the phrase extracting unit 12 (S02). Subsequently, a phrase included in the sentence is converted into a candidate phrase for an entity linked to the phrase by the candidate converting unit 13 (S03). Subsequently, a combination of phrases, which includes converted phrases, corresponding to the sentence is generated by the combination generating unit 14 (S04). Subsequently, a score is calculated by the score calculating unit 15 for each combination on the basis of scores of similarities between phrases included in the combination (S05). Subsequently, a phrase of an entity linked from a candidate phrase is identified and output by the entity identifying unit 16 on the basis of the scores of the combinations (S06). The process executed by the entity identification system 10 according to this embodiment has been described as above.

In this embodiment, a phrase of an entity linked to a phrase included in a sentence is identified on the basis of similarity between phrases corresponding to the sentence. Thus, according to this embodiment, an entity that is appropriate for a context of a sentence can be identified. In addition, when a similarity between phrases is calculated in advance, an entity can be identified by performing a relatively simple process compared to a conventional case of identifying an entity. In other words, according to this embodiment, the processing load for identifying an entity can be reduced.

In addition, as described above, phrases may be extracted from a sentence on the basis of a corpus. According to such a configuration, a phrase that is a target for identifying an entity can be appropriately extracted. However, a corpus does not necessarily need to be used for extracting phrases.

In addition, as described above, a similarity between phrases may be calculated on the basis of the corpus. According to such a configuration, the similarity between phrases can be calculated appropriately and reliably, and, as a result, an entity that is appropriate for a context of a sentence can be identified appropriately and reliably. However, the similarity between phrases need not necessarily be based on a corpus.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by one device that is combined physically or logically or a plurality of devices by directly or indirectly (for example, using a wire, wirelessly, or the like) connecting two or more devices separated physically or logically. A functional block may be realized by combining software with one device or the plurality of devices described above.

As functions, there are determining, judging, calculating, computing, processing, deriving, investigating, looking up, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but the functions are not limited thereto. For example, a functional block (component unit) allowing a function of transmitting may be referred to as a transmitting unit or a transmitter. As described above, methods of realizing all the functions are not particularly limited.

For example, the entity identification system 10 according to one embodiment of the present disclosure may function as a computer that performs information processing of the present disclosure. FIG. 6 is a diagram illustrating one example of the hardware configuration of the entity identification system 10 according to one embodiment of the present disclosure. The entity identification system 10 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the entity identification system 10 may be configured to include one or a plurality of devices illustrated in the drawing and may be configured without including some of these devices.

Each function of the entity identification system 10 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, each function of the entity identification system 10 may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, each function of the entity identification system 10 may be realized by a control program that is stored in the memory 1002 and operated by the processor 1001. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing information processing according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium included in the entity identification system 10, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the entity identification system 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be performed in a modified or changed form without departing from the concept and the scope of the present disclosure set in accordance with the claims. Thus, the description presented in the present disclosure is for the purpose of exemplary description and does not have any limiting meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology such as infrared rays, radio waves, microwaves, or the like, at least one of such a wiring technology and a radio technology is included in the definition of the transmission medium.

Terms such as “system” and “network” used in the present disclosure are interchangeably used.

In addition, information, a parameter, and the like described in the present disclosure may be represented using absolute values, relative values with respect to predetermined values, or other corresponding information.

At least one of a server and a client may be referred to as a transmission device, a reception device, a communication device, or the like. In addition, at least one of a server and a client may be a device mounted in a moving body, a moving body, or the like. The moving body may be a vehicle (for example, a car, an airplane, or the like), a moving body moving in an unmanned manner (for example, drone, an automated driving vehicle, or the like), or a robot (a manned type or an unmanned type). In addition, at least one of a server and a client includes a device that does not necessarily move at the time of a communication operation. For example, at least one of a base station and a moving station may be an Internet of things (TOT) device such as a sensor or the like.

In addition, a server in the present disclosure may be rephrased by a client terminal. For example, each aspect/embodiment of the present disclosure may be applied to a configuration acquired by replacing communication between a server and a client terminal with communication among a plurality of user terminals (for example, may be referred to as Device-to-Device (D2D), Vehicle-to-Everything (V2X), or the like). In such a case, the function of the server described above may be configured to be included in the client terminal.

Similarly, the client terminal in the present disclosure may be rephrased as a server. In such a case, the function of the client terminal described above may be configured to be included in the server.

Terms such as “determining” used in the present disclosure may include various operations of various types. “Determining,” for example, may include a case in which judging, calculating, computing, processing, deriving, investigating, looking up (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining” In other words, “determining” includes a case in which a certain operation is regarded as “determining.” In addition, “determining” may be rephrased with “assuming,” “expecting,” “considering,” or the like.

Terms such as “connected” or “coupled” or all the modifications thereof mean all kinds of direct or indirect connection or coupling between two or more elements and the presence of one or more intermediate elements between two elements that are mutually “connected” or “coupled” is included. Coupling or connection between elements may be physical coupling or connection, logical coupling or connection, or a combination thereof. For example, “connection” may be rephrased as “access.” When used in the present disclosure, two elements may be considered as being mutually “connected” or “coupled” when using at least one of one or more wires, cables, and print electric connections and, as several non-limiting and non-comprehensive examples, by using electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “at least on the basis of.”

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, an expression “A and B are different” may mean that “A and B are different from each other.” In addition, the expression may mean that “A and B are different from C.” Terms such as “separated,” “coupled,” and the like may be interpreted to be similar to being “different.”

### REFERENCE SIGNS LIST

10 Entity identification system
11 Input unit
12 Phrase extracting unit
13 Candidate converting unit
14 Combination generating unit
15 Score calculating unit
16 Entity identifying unit
1001 Processor
1002 Memory
1003 Storage
1004 Communication device
1005 Input device
1006 Output device
1007 Bus

1. An entity identification system comprising circuitry configured to:
input a sentence;
extract one or more phrases from the input sentence;
convert at least one of the extracted phrases into one or more candidate phrases for an entity linked to the phrase;
generate one or more combinations of phrases, which correspond to the sentence, each including one of the one or more candidate phrases;
calculate a score of each of the combinations on the basis of a score for a similarity between phrases included in the combination; and
identify a phrase for the linked entity from among the one or more candidate phrases on the basis of the scores of the combinations.

2. The entity identification system according to claim 1, wherein the circuitry inputs a corpus and extracts phrases from the sentence on the basis of the input corpus.

3. The entity identification system according to claim 1, wherein circuitry inputs a corpus and calculates a score for a similarity between phrases on the basis of the input corpus.

4. The entity identification system according to claim 2, wherein circuitry inputs a corpus and calculates a score for a similarity between phrases on the basis of the input corpus.
